(19) United States
(12) Patent Application Publication
(10) Pub. No.: US 2006/0034028 A1
(43) Pub. Date: Feb. 16, 2006

(54) Power down protection circuit

(75) Inventor: Ming-Chin Hsieh, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/203,392

(22) Filed: Aug. 11, 2005

(30) Foreign Application Priority Data
Aug. 11, 2004 (CN) 200410051097.5

(51) Int. Cl. H02H 3/00

(52) U.S. Cl. 361/100

(57) ABSTRACT

A power down protection circuit is interpositioned between a power supply (20) and a reset pin (21) of a system chip. The circuit includes a bipolar junction transistor (BJT) (11), a first resistor (12), a second resistor (13), a third resistor (14), a first reference power source (15), and a second reference power source (16). The power supply is connected one end of the first resistor, the other end of the first resistor is connected to an emitter of the BJT, a base of the BJT is connected to the first reference power source via the second resistor, a collector of the BJT is connected to the second reference power source via the third resistor and is also connected to the reset pin of the system chip. When the power supply voltage drops, the circuit generates a reset signal automatically. The circuit is relatively simple, compact, and cost-effective.

### BACKGROUND OF THE INVENTION

1. Field of the Invention

The present invention pertains to power down protection circuits, and more particularly to a power down protection circuit for outputting a signal to an integrated circuit (IC) powered by a power supply, when the power supply is abruptly shut-off or the voltage of the power supply is lower than a threshold value.

2. Related Art

Generally, most electronic circuits require steady power supplies to ensure normal operation. For example, a microcontroller generally requires a 5 volts DC power supply. If the power supply is cut off or the power supply voltage falls below 5 volts, the microcontroller may not operate normally. Therefore, it is necessary to provide a power down protection circuit between the power supply and the microcontroller. When the power supply is shut off abruptly or the voltage of the power supply is lower than a threshold value, the power down protection circuit generates a reset signal automatically. When the microcontroller receives the reset signal, operation of the microcontroller is reset. When the voltage of the power supply returns to normal, the microcontroller is restarted.

FIG. 2 illustrates a convention power down protection circuit, which includes a bipolar junction transistors (BJT) 1, three resistors 2, 3, 4, a power supply 5, and a comparator 6. A collector of the BJT 1 is connected to ground. A base of the BJT 1 is connected to the collector via a conducting wire. An emitter of the BJT 1 is connected to one end of the resistor 2. The other end of the resistor 2 is connected to the power supply 5. A voltage of a node 8 between the emitter of the BJT 1 and the resistor 2 is represented as V1. The node 8 is connected to the cathode of the comparator 6 via a conducting wire. One end of the resistor 3 is connected to the power supply 5, and the other end of the resistor 3 is connected to ground via the resistor 4. A voltage of a node 9 between the resistor 3 and the resistor 4 is represented as V2. The node 9 is connected to an anode of the comparator 6 through a conducting wire. The comparator 6 generates a voltage signal by comparing V1 and V2. When V2 is lower than V1, the output end 7 outputs a reset signal “0.” When V2 is higher than V1, the output end 7 outputs a high voltage signal “1.” In summary, the power down protection circuit can generate a reset signal when the power supply voltage drops. However, it is rather bulky and relatively expensive.

Therefore, a heretofore unaddressed need exists in the industry to address the aforementioned deficiencies and inadequacies.

### SUMMARY OF THE INVENTION

A power down protection circuit is interpositioned between a power supply and a system chip having a reset pin. The power down protection circuit includes a bipolar junction transistor (BJT), a first resistor, a second resistor, a third resistor, a first reference power source, and a second reference power source. The power supply is connected to one end of the first resistor. The other end of the first resistor is connected to an emitter of the BJT. A base of the BJT is connected to the first reference power source via the second resistor. A collector of the BJT is connected to the second reference power source via the third resistor and is also connected to the reset pin of the system chip. A voltage of the first reference power source is equal to a normal voltage of the power supply. A voltage of the second reference power source is equal to a normal working voltage of the reset pin of the system chip. When the power supply voltage is lower than the voltage of the first reference power source voltage, the BJT is turned on. When the power supply voltage is equal to or higher than the voltage of the first reference power source voltage, the BJT is turned off. When the BJT is turned on, a reset signal is generated and is sent to the reset pin of the system chip, the system chip is reset. When the BJT is turned off, the system chip resumes normal working.

The inventive power down protection circuit adopts an on-off character of the BJT, and omits the comparator of the above-described conventional power down protection circuit. The inventive power down protection circuit is relatively simply, compact, and cost-effective.

Other advantages and novel features will be drawn from the following detailed description when taken in conjunction with the accompanying drawings, in which:

### BRIEF DESCRIPTION OF THE DRAWINGS

FIG. 1 is a circuit diagram of a power down protection circuit according to a preferred embodiment of the present invention; and

FIG. 2 is a circuit diagram of a conventional power down protection circuit.

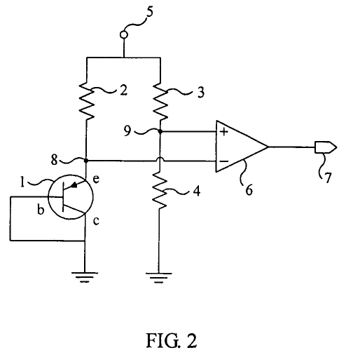

### DETAILED DESCRIPTION OF PREFERRED EMBODIMENT

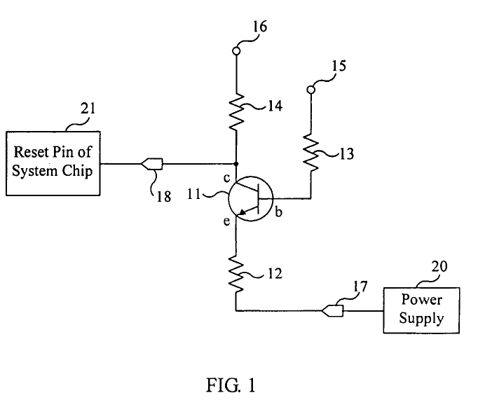

FIG. 1 illustrates a power down protection circuit according to a preferred embodiment of the present invention. The power down protection circuit is provided between a power supply 20 and a reset pin 21 of an integrated circuit (for example, a system chip) or a logic circuit. The power down protection circuit is utilized to automatically trigger the system chip to self-reset whenever the power of the power supply 20 accidentally falls below a predetermined threshold value. When the power supply 20 is shut-off abruptly of falls below the threshold value, the power down protection circuit generates a reset signal and sends the signal to the reset pin 21 of the system chip. The power down protection circuit includes a bipolar junction transistor (BJT) 11, an emitter resistor 12, a base resistor 13, a collector resistor 14, a first reference power source 15, a second reference power source 16, an input end 17, and an output end 18.

The power supply 20 is connected to one end of the emitter resistor 12 via the input end 17. The other end of the emitter resistor 12 is connected to an emitter of the BJT 11. Abase of the BJT 11 is connected to a first reference power source 15 via the base resistor 13. A collector of the BJT 11 is connected to a second reference power source 16 via the collector resistor 14. The collector of the BJT 11 is also connected to the reset pin 21 of the system chip via the output end 18.

In the preferred embodiment, a normal working voltage range of the reset pin 21 of the system chip ranges from +2.6 volts to +3.6 volts. The power supply 20 is a +5 volt direct current (DC) power supply. The BJT 11 is a NPN-type (negative-position-negative-type) BJT. A voltage of the first reference power source 15 is +5 volts. A voltage of the second reference power source 16 is +3.3 volts. The resistances of the emitter resistor 12, the base resistor 13 and the collector resistor 14 are all 10 kilohms. When the system chip is operating, the voltage of the reset pin 21 keeps 3.3 volts. If the reset pin 21 receives a “0 volts” low voltage signal, the system chip is triggered to self-reset. Subsequently, if the reset pin 21 receives a “3.3 volts” high voltage signal again, the system chip is restarted.

When the voltage of the power supply 20 is lower than +5V, the base voltage V_{b} of the BJT 11 is higher than the emitter voltage Vₑ of the BJT 11. When the base-emitter voltage V_{be} is higher than a threshold voltage of the BJT 11, the BJT 11 is turned on. Thus the voltage of the collector V_{c} of the BJT 11 drops to 0 volts. The output end 18 outputs a reset signal to the reset pin 21 of the system chip. When the reset pin 21 of the system chip receives the reset signal, the system chip is self-reset.

Subsequently, when the voltage of the power supply 20 is increased up to +5 volts, the emitter voltage Vₑ is equal to the base voltage V_{b}, and the BJT 11 is then turned off. At this time, there is no current flowing from the collector to the base of the BJT 11, so the collector voltage V_{c} is equal to the voltage of the second reference power source 16. The output end 18 outputs a high voltage signal to the reset pin 21 of the system chip. When the reset pin 21 of the system chip receives the high voltage signal, the system chip is restarted.

In the illustrated embodiment, the voltage of the power supply 20 is +5 volts, and the normal working voltage range of the reset pin 21 of the system chip is in the range from +2.6 volts to +3.3 volts. For other power supplies and system chips, the voltage of the first reference power source 15 should be the same as the normal voltage of the power supply 20, and the voltage of the second reference power source 16 should be the same as the normal working voltage of the reset pin 21 of the system chip. Accordingly, the power down protection circuit can be adapted for application to various different kinds of power supplies and system chips with different working voltages.

Although only an exemplary embodiment has been described in detail above, those skilled in the art will readily appreciate that many modifications to the exemplary embodiment are possible without materially departing from the novel teachings and advantages of the present invention. Accordingly, all such modifications are intended to be covered by the following claims and allowable equivalents of the claims.

We claim:

1. A power down protection circuit for being interpositioned between a power supply and a system chip having a reset pin, the power down protection circuit comprising:
a first resistor having a first end being for connection to the power supply;
a bipolar junction transistor (BJT) having a base, a collector and an emitter, the emitter of the BJT being connected to a second opposite end of the first resistor, the collector of the BJT being for connection to the reset pin of the system chip;
a second resistor having a first end connected to the base of the BJT;
a third resistor having a first end connected to the collector of the BJT;
a first reference power source connected to a second opposite end of the second resistor; and
a second reference power source connected to a second opposite end of the third resistor.

2. The power down protection circuit as recited in claim 1, wherein a voltage of the first reference power source is equal to a normal voltage of the power supply.

3. The power down protection circuit as recited in claim 1, wherein a voltage of the second reference power source is equal to a normal working voltage of the reset pin of the system chip.

4. The power down protection circuit as recited in claim 1, wherein the BJT is an NPN-type (negative-positive-negative-type) BJT.

5. A power down protection circuit, comprising:
an input end for being coupled to a power supply;
an output end for outputting a reset signal or a restart signal;
a first reference power source;
a second reference power source; and
a switch having a switch control end and first and second connection ends, the first connecting end being connected to a first reference power source via a first resistor, the second connecting end being connected to a second reference power source via a second resistor, the switch control end being connected to the input end via a first resistor, the switch being operable between a first state where the input voltage is lower than a voltage of the first reference power source, and the output end outputs a reset signal, and a second state where the input voltage is equal to or higher than the first reference power source, and the output end outputs a restart signal.

6. The power down protection circuit as recited in claim 5, wherein a voltage of the first reference power source is equal to a normal input voltage of the input end.

7. The power down protection circuit as recited in claim 5, wherein the switch is a bipolar junction transistor (BJT).

8. A power down protection circuit, comprising:
a logic circuit capable of normal working by being supplied with a first voltage of power, and capable of being reset by being supplied with a lower voltage of power than said first voltage of power;
a power supply preset to provide a second voltage of power output;
a first reference power source preset to provide a power output substantially same as said second voltage of said power supply;
a second reference power source preset to provide a power output substantially same as said first voltage of said logic circuit, said second reference power source electrically connected with said logic circuit; and
a switch electrically connected with said logic circuit, said power supply and said first and second reference power sources respectively, said switch being in a first state to supply said logic circuit with said first voltage of power for said normal working of said logic circuit when said power output of said power supply is identifiably same as said power output of said first reference power source, and in a second state to supply said logic circuit with said lower voltage of power for resetting said logic circuit when said power supply is not identifiably same as said power output of said first reference power source.

9. The power down protection circuit as recited in claim 8, wherein said switch is a bipolar junction transistor (BJT).

10. The power down protection circuit as recited in claim 9, wherein a base of said BJT is electrically connected with said first reference power source, an emitter of said BJT is electrically connected with said power supply, and a collector of said BJT is electrically connected with said second reference power source and said logic circuit respectively.

11. The power down protection circuit as recited in claim 8, wherein said lower voltage value of power for resetting said logic circuit is 0 volts as said power supply is shut down.
